(19) United States
(12) Patent Application Publication
(10) Pub. No.: US 2012/0127136 A1
(43) Pub. Date: May 24, 2012

(54) DISPLAY DEVICE INCLUDING PIEZOELECTRIC AND LIQUID CRYSTAL LAYERS

(75) Inventors: Tod SCHNEIDER, Kent, OH (US); Erica MONTBACH, Sterling, OH (US); J. William Doane, Tallmadge, OH (US); Antal JAKLI, Tallmadge, OH (US); John HARDEN, Tallmadge, OH (US)

(73) Assignee: KENT DISPLAYS INCORPORATED, Kent, OH (US)

(21) Appl. No.: 13/212,697

(22) Filed: Aug. 18, 2011

Related U.S. Application Data
(60) Provisional application No. 61/374,801, filed on Aug. 18, 2010.

(51) Int. Cl. G02F 1/1343; G06F 3/038; G02F 1/1347; G02F 1/1333; G02F 1/1334

(52) U.S. Cl. 345/204; 349/23; 349/12

(57) ABSTRACT

A display device includes a piezoelectric layer. First electrically conductive electrodes are disposed on both sides of the piezoelectric layer. A bistable liquid crystal layer is disposed adjacent the piezoelectric layer. Second electrically conductive electrodes are disposed on both sides of the liquid crystal layer. The liquid crystal layer can be addressed by electrically addressing the piezoelectric layer causing the piezoelectric layer to move into contact with the liquid crystal layer, changing the brightness of pixels of the liquid crystal layer.

### TECHNICAL FIELD

This disclosure pertains to a display device that includes piezoelectric and liquid crystal layers, wherein the liquid crystal layer can be addressed by pressure caused by electrically addressing the piezoelectric layer.

### BACKGROUND OF THE DISCLOSURE

Cholesteric materials are known for their pressure sensitivity and are used for writing tablets; see U.S. Pat. No. 6,104,448. When a cholesteric material with a suitable pitch length is sandwiched between two substrates it can be made to exhibit two visibly different textures, a reflective planar texture that reflects colored light and a weakly light scattering focal conic texture that is transparent to the eye when the bottom substrate is adjacent to a dark background. If the upper substrate is flexible, the slight pressure of a pointed stylus applied to the substrate will locally reduce the spacing between the substrates inducing flow in the cholesteric liquid crystal, i.e., strain the cholesteric liquid crystal layer, causing it to change from the transparent focal conic texture to a color reflective planar texture creating image. A voltage applied to electrodes on the surface of the substrates adjacent to the cholesteric material can be used to electrically switch the material from the planar back to the focal conic texture, erasing the image. A writing tablet using this effect is commercialized by Kent Displays, Inc. under the name Boogie Board™ (Kent Displays, Inc., Kent Ohio).

Another mode of tablet operation is described in U.S. Patent Application Publication 2009/0033811. This application discloses a multiple color writing tablet in which a stack of cholesteric liquid crystal layers, each reflective in a different primary color, can be used to draw multiple color images. In yet another patent publication 2009/0096942, a selective erase tablet device is disclosed that takes advantage of a reduced voltage in a region of the display where pressure applied to electrically drive the reflective planar texture to the transparent focal conic texture, erasing the image in that region without erasing images where pressure is not applied.

The tablet has many uses but its utility could be greatly extended if an image could also be digitally addressed on the tablet. Images traced on the tablet and captured by a touch screen (U.S. Provisional Patent Application 61/181,716) could then be recalled on the tablet. More importantly the tablet itself could be used as a display for displaying any digital image.

A display device has been disclosed in U.S. Pat. No. 7,834,942 that uses pressure to create a uniform reflective planar texture. An image is then written by electrically driving the focal conic texture. With this display, limitations on the thickness of the cholesteric layer, are mitigated as compared to normal cholesteric reflective display that drives the reflective planar texture electrically (see, for example, the book chapter by J. W Doane and A. Khan, Flexible Displays (Ed. G. Crawford) John Wiley and Sons, Chapter 17 (2005).

Piezoelectricity, a linear coupling between stress and electric polarization, was discovered in 1880 by Pierre and Jacques Curie. One year later Lippmann proposed, on the basis of thermodynamic principles that the inverse effect (electrically induced pressure) must exist too. The Curie brothers were also those who experimentally verified this converse piezoelectric effect.

Experiments show that today's piezoelectric sensors and actuators have piezoelectric constants in the range of 10⁻¹⁰-10⁻⁹ C/N, which render them useful in a wide range of applications starting from the long time known ultrasonics and hydroacoustics, frequency standards and ferroelectric ceramics used in sensors, transducers, vibration dampeners and energy harvesters. Recent important summaries of ferroelectric films for microsensors and actuators were published by Murailt. Integrated piezoelectric sensors for were published by Minne et al. and Palla et al.

### TECHNICAL SUMMARY

We disclose means of addressing a digital image on a pressure sensitive liquid crystal layer (e.g., a writing tablet) using materials that exhibit the piezoelectric effect. A plurality of innovations associated with this invention is disclosed.

We disclose a hybrid reflective display device using piezoelectricity and electric fields to digitally address the planar texture image on a bistable cholesteric layer. A piezoelectric film or layer, with transparent conducting electrodes on both sides of the layer, is placed adjacent (e.g., in mechanical contact) with a cholesteric liquid crystal film or layer. At least one of those electrodes sandwiching the piezoelectric layer is patterned. The cholesteric liquid crystal layer is preferably in the form of a polymer dispersion such as that used in a Boogie Board™ writing tablet. Transparent conducting electrodes are placed on each side of the cholesteric liquid crystal layer, sandwiching the layer. There also may be intervening layers between an electrode of the cholesteric layer and the adjacent electrode of the piezoelectric film such as a dielectric layer. When a voltage of suitable magnitude is applied to the electrodes on the piezoelectric film, the piezoelectric film changes shape and strains the cholesteric film such as to induce flow of the cholesteric liquid crystal material to locally drive the cholesteric material to the planar texture or to exhibit gray scale. The cholesteric liquid crystal material can be placed in the focal conic texture by application of voltage to the electrodes sandwiching the liquid crystal layer during, before, or after being changed to the planar texture by voltages applied to the piezoelectric film. This method of driving the planar texture in a cholesteric material is especially advantageous compared to prior art, namely the electrical driving method of U.S. Pat. Nos. 5,437,811 and 5,493,863 whereby an applied electric field drives the cholesteric material to the homeotropic texture then upon quick removal the material relaxes to the planar texture; see for example the book chapter by J. W Doane and A. Khan, Flexible Displays (Ed. G. Crawford) John Wiley and Sons, Chapter 17 (2005). In this prior art, the relaxation times are relatively long, generally tens or hundreds of milliseconds slowing the addressing time. Also a problem with this prior art is the homeotropic state causes undesirable artifacts in imaging cholesteric displays. Addressing the planar texture with piezoelectric films is disclosed in order to avoid these artifacts and dramatically speed up the addressing time. Voltages (e.g., voltage pulses) are applied to the electrodes sandwiching the piezoelectric film and to the electrodes sandwiching the liquid crystal layer using suitable drive electronics, for example, including an amplifier and a waveform generator.

Piezoelectric materials suitable for this application include polymeric materials, the most commonly known of which is polyvinilidene fluoride (PVDF). The raw PVDF (a-phase) does not have intrinsic piezoelectric properties, however if it polarized during the manufacturing process, it transforms to b-phase which is piezoelectric. They have been used for many transducer applications, such as sonar, medical, ultrasonic equipment, robot tactile sensors, force and strain gages, etc.

Piezoelectric ceramics can be stronger than PVDF. The most known of them, which are lead zirconium titanate (PZT) ceramics, are high performance piezoelectric materials. These are widely used in sensors, actuators and other electronic devices. Recently an alkaline niobate-based perovskite solid solution was reported. The ceramic exhibits a piezoelectric constant d(33) (the induced charge per unit force applied in the same direction) of above 300 picocoulombs per newton (pCN(−1)), and texturing the material leads to a peak d(33) of 416 pCN(−1). Films can be made that incorporate these ceramic materials as a composite consisting of an aggregate of microcrystalline piezoelectric particles dispersed in a polymer. Such a material can be cast as a film and functions similar to the PVDF film described above; however, lower voltages may be used to drive the material.

While this disclosure focuses on the use of cholesteric liquid crystal materials, it should be understood that bistable or surface stabilized TN or STN displays may be used in place of the cholesteric layer sandwiched by electrode layers.

2) We disclose a hybrid display as in 1) above with an array of pixels for displaying a digitally addressed image. The pixels are created by a matrix of electrodes obtained by pattering the conducting electrode of the piezoelectric layer, distal to the liquid crystal layer, as columns and the other conducting electrode sandwiching the piezoelectric layer remaining unpatterned or continuous. The conducting electrode of the cholesteric liquid crystal layer distal to the piezoelectric layer is patterned as rows and the other electrode sandwiching the liquid crystal is continuous or unpatterned. The rows and the columns are approximately orthogonal to one another with pixels defined by the intersection of the rows and columns. An insulating dielectric layer is located between the unpatterned electrode of the liquid crystal layer and the unpatterned electrode of the piezoelectric layer.

3) We disclose a multiplexed driving scheme for 1) and 2) above whereby the electrodes on the piezoelectric layer are electrically driven one column at a time. Each driven column defines a line segment of the image. While each column is driven by the piezoelectric film, data is simultaneously placed on that corresponding line segment by voltages applied to rows of the electrodes sandwiching the liquid crystal layer. The data voltages drive the focal conic texture while the piezoelectric film drives the planar texture. Image data is therefore addressed to the display one line at a time sequentially to create a full image. Crosstalk between the line or column being driven by the piezoelectric film and the other undriven lines is prevented when the data voltage required to create a focal conic state by the data voltages is less for the piezoelectric driven line than those lines not being driven. This is a feature that is possible in part because the inter-electrode spacing is reduced during the time the column is driven by the piezoelectric film.

4) We disclose a hybrid display as in 2) and 3) above in which the unpatterned electrodes between the liquid crystal later and the piezoelectric layer are shared. This display configuration is possible when the voltages driving the piezoelectric film do not create a field across the liquid crystal layer of sufficient magnitude to interfere with that of the data voltages.

5) We disclose a hybrid display as in 2), 3) and 4)) above where gray levels (controlled levels of reflective brightness) for each pixel are achieved by controlling the data voltages.

6) We disclose a hybrid display as in 1) where the piezoelectric layer is sandwiched between conducting electrode layers one of which is patterned as rows and the other patterned orthogonally as columns. The cholesteric liquid crystal layer is sandwiched between two conducting electrodes both of which may be unpatterned or one distal to the piezoelectric film patterned as rows.

7) We disclose a multiplex driving scheme for the hybrid display of 6) for cases where the piezoelectric film has a threshold sufficient to prevent crosstalk for line-at-a-time driving. Shades of gray or levels of reflective brightness are achieved by data voltages applied to the electrodes of the liquid crystal layer. The image is erased by a voltage applied to the liquid crystal electrodes.

8) We disclose a hybrid display as in 1) above where the electrodes sandwiching the liquid crystal layer are patterned. One of the electrodes sandwiching the piezoelectric layer is patterned as columns, the other unpatterned. An image is addressed on the display by first driving each line on the display to the planar texture by sequentially applying appropriate voltages to the columns of the piezoelectric electrodes. A focal conic image is then placed on the display with a planar background by applying voltages to patterned electrodes of the liquid crystal material.

9) We disclose a hybrid display as in 6) where the piezoelectric layer is sandwiched between conducting electrode layers one of which is an active matrix with thin film transistor (TFT) elements and the other is unpatterned or continuous. The active matrix allows each pixel of the piezoelectric layer to be individually driven.

10) We disclose the use of conducting polymer electrodes for the PVDF, P(VDF-TrFE) (discussed in the examples), or other piezoelectric films to maintain their transparency and for convenience in liquid crystal display fabrication.

11) We disclose the use of indium tin oxide electrodes on PVDF, P(VDF-TrFE), or other piezoelectric films to maintain their transparency and create a low resistance conducting surface.

12) We disclose the use of conductive carbon nanotubes on PVDF, P(VDF-TrFE), or other piezoelectric films to maintain their transparency and for convenience in liquid crystal display fabrication.

13) We disclose the use of conductive carbon on PVDF, P(VDF-TrFE), or other piezoelectric films for display constructions that do not require transparency.

14) We disclose a hybrid display device as in 1) above with one, two, or three different cholesteric layers being simultaneously driven by one piezoelectric (e.g., PVDF) film. The cholesteric layers may be of opposite chiral handedness to provide a display of high reflective brightness. The cholesteric layers may also reflect different colors (e.g., red, green and blue) to allow color mixing and multiple colors.

15) We disclose a triple stack of hybrid displays as in 1) above containing both cholesteric and at least one or more piezoelectric layers to achieve a full color response. In particular, for example, each cholesteric liquid crystal layer is driven by a different piezoelectric layer.

16) We disclose a single cholesteric layer hybrid display as in 1) above where the piezoelectric layer drives subpixels of primary red, green, blue reflective colors to achieve full color operation.

17) We disclose a hybrid display as in 1) above using a piezoelectric material that is a composite of particles of a piezoelectric material dispersed in a polymeric material.

18) We disclose the piezoelectric materials used in the hybrid display as in 1) above which can be ceramic piezoelectric particles of lead zirconate titantate (PZT), barium titanate (BaTiO₃), lead titanate (PbTiO₃), potassium niobate (KNbO₃), lithium niobate (LiNbO₃), lithium tantalite (LiTaO₃), sodium tungstate (Na₂WO₃), sodium potassium niobate (NaKNb), sodium niobate (NaNbO₃), bismuth ferrite (BiFeO₃), Ba₂NaNb₅O₅, and/or Pb₂KNb₅O₁₅.

19) We disclose a piezoelectric material as in 1), 17) and 18) above where the piezoelectric layer includes piezoelectric particles that are uniform to an average diameter from 1 to 300 micrometers.

20) We disclose a piezoelectric material as in 1), 17) and 18) above where the piezoelectric layer includes piezoelectric particles that are uniform to an average diameter from 1 to 1000 nanometers.

21) We disclose a hybrid display with the piezoelectric film comprised of a composite of piezoelectric crystallites dispersed in a polymer binder as in 1) 17), 18), 19) and 20) above.

22) We disclose a hybrid display as in 1) above with the piezoelectric film comprised of a composite of piezoelectric crystallites dispersed in a piezoelectric polymer binder such as PVDF or P(VDF-TrFE).

23) We disclose a hybrid display device as in 1) above with piezoelectric particles dispersed in the bottom substrate.

24) We disclose a hybrid display device with piezoelectric particles disbursed in a polymeric binder such as 1) 21) or 22) that are screen printed through a patterned screen onto the bounding substrate of the cholesteric layer so as to define the piezoelectric area that will drive the pixel(s).

25) We disclose a hybrid display device as in 1) above with an overcoat of the bottom substrate that contains the cholesteric material with piezoelectric particles dispersed in a polymer.

26) We disclose a hybrid display device as in 1) above with an overcoat on one of the substrates that contains the cholesteric material with piezoelectric particles dispersed in a material that separates and does not dissolve in the cholesteric liquid crystalline material.

27) We disclose a hybrid display device as in 1) above containing continuous electrodes on the top and bottom substrates of the cholesteric layer where the bottom substrate is mechanically coupled to ceramic piezo posts that are individually electronically driven to address the display.

28) We disclose a hybrid display device as in 1) above containing patterned electrodes on the top (rows) and bottom (columns) substrates of the cholesteric layer where the bottom substrate is mechanically coupled to ceramic piezo posts that are individually electronically driven to address the display.

In general, a first inventive concept of this disclosure features a display device including a piezoelectric layer. First electrically conductive electrodes are disposed on both sides of the piezoelectric layer. A bistable liquid crystal layer is disposed adjacent the piezoelectric layer. Second electrically conductive electrodes are disposed on both sides of the liquid crystal layer.

Referring to specific features of this first inventive concept, drive electronics can be included for applying a first voltage to the first electrodes and a second voltage to the second electrodes. The liquid crystal can be a cholesteric liquid crystal. The first voltage can be applied to the first electrodes at a magnitude that causes the piezoelectric film to change shape which in turn causes flow of liquid crystal of the liquid crystal layer, thereby driving a planar texture of the liquid crystal. The second voltage can be applied to the second electrodes at a magnitude that drives a focal conic texture of the cholesteric liquid crystal. At least one of the first electrodes and/or at least one of the second electrodes is patterned. The liquid crystal layer can comprise a dispersion of the cholesteric liquid crystal in a polymer matrix. Each of the first voltage and the second voltage can comprise a voltage pulse. A flexible substrate can cover the liquid crystal layer. The substrate, the liquid crystal layer and the second electrodes can comprise a writing tablet on which a texture of the cholesteric liquid crystal can be changed by application of pressure to the substrate. A light absorbing layer can be disposed at a back of the display device (i.e., downstream of the liquid crystal layer and the piezoelectric layer in a direction of incident light). An electrically insulating layer can be disposed between one of the first electrodes and an adjacent one of the second electrodes. The first electrodes can include an unpatterned electrode and the second electrodes can include an unpatterned electrode both located between the liquid crystal layer and the piezoelectric layer and being the same electrode.

A second inventive concept of this disclosure features a display device including a piezoelectric layer. First electrically conductive electrodes are disposed on both sides of the piezoelectric layer. A bistable liquid crystal layer comprises cholesteric liquid crystal. The liquid crystal layer is adjacent the piezoelectric layer and comprises a dispersion of the cholesteric liquid crystal in a polymer matrix. Second electrically conductive electrodes are disposed on both sides of the liquid crystal layer. At least one of the second electrodes is transparent. Drive electronics apply a first voltage to the first electrodes and a second voltage to the second electrodes. The first voltage is applied to the first electrodes at a magnitude that causes the piezoelectric film to change shape which in turn causes flow of the cholesteric liquid crystal, thereby driving a planar texture of the cholesteric liquid crystal. The second voltage is applied to the second electrodes at a magnitude that drives a focal conic texture of the cholesteric liquid crystal.

Turning to specific aspects of this second inventive concept, the first voltage and the second voltage can each comprise a voltage pulse. A flexible substrate can cover the liquid crystal layer. The substrate, the liquid crystal layer and the second electrodes can comprise a writing tablet on which a texture of the cholesteric liquid crystal can be changed by application of pressure to the substrate. A light absorbing layer can be disposed at a back of the display device. At least one of the first electrodes can be patterned. The first or second electrodes can be made of a material selected from the group consisting of conducting polymer, indium tin oxide, carbon nanotubes, conductive carbon, and combinations thereof.

Regarding further specific features of the second inventive concept, an array of pixels of the liquid crystal layer can display a digitally addressed image. The pixels are created by a matrix of electrodes obtained by patterning one of the first electrodes as one of columns or rows and the other of the first electrodes sandwiching the piezoelectric layer being unpatterned. One of the second electrodes is patterned as the other of the columns or rows and the other of the second electrodes sandwiching the liquid crystal layer is unpatterned. The rows and columns are approximately orthogonal to one another with the pixels being defined by an intersection of the rows and columns. An insulating dielectric layer can optionally be located between the unpatterned first electrode and the unpatterned second electrode. The unpatterned first electrode and the unpatterned second electrode can be located between the liquid crystal layer and the piezoelectric layer and can be the same electrode.

Regarding further specific features of the second inventive concept, one of the first electrodes can be patterned as rows and the other of the first electrodes can be patterned as columns. The rows and the columns are substantially orthogonal to each other. Both of the second electrodes are unpatterned. Alternatively, one of the second electrodes is patterned as rows or columns and the other of the second electrodes is unpatterned.

Regarding still additional specific features of the second inventive concept, the liquid crystal layer can be comprised of at least two or three different liquid crystal layers comprising the cholesteric liquid crystal. Each of the liquid crystal layers is sandwiched by the second electrodes. At least two of the liquid crystal layers can be formed of cholesteric liquid crystal of opposite chiral handedness. The liquid crystal layers can include the cholesteric liquid crystal that reflects at least two of the colors of red, green and blue. Each of the liquid crystal layers can reflect light of a different color. Only a single piezoelectric layer need be used for driving all of the liquid crystal layers. There can be three of the liquid crystal layers each reflecting a different one of red, green and blue. Three of the piezoelectric layers can each be disposed each adjacent one of the three liquid crystal layers.

Other additional specific features of the second inventive concept are that the liquid crystal layer can include subpixels that reflect light of red, green and blue colors. The piezoelectric layer can comprise a composite of particles of a piezoelectric material dispersed in a polymeric material. The piezoelectric layer can comprises piezoelectric particles selected from the group consisting of: lead zirconate titantate, barium titanate, lead titanate, potassium niobate, lithium niobate, lithium tantalite, sodium tungstate, sodium potassium niobate, sodium niobate, bismuth ferrite, Ba₂NaNb₅O₅, Pb₂KNb₅O₁₅, and combinations thereof. The piezoelectric layer can be comprised of piezoelectric particles having an average diameter ranging from 1 to 300 micrometers or ranging from 1 to 1000 nanometers. The piezoelectric layer can comprise a composite of piezoelectric crystallites dispersed in a polymer binder. The piezoelectric layer can comprise polyvinylidene fluoride or a copolymer blend of poly(vinylidene fluoride) and trifluoroethylene. The piezoelectric layer can form a bottom substrate of the display device.

Still other features of the second inventive aspect are that a substrate can be disposed between the liquid crystal layer and the piezoelectric layer. The piezoelectric layer can comprise piezoelectric particles disbursed in a polymeric binder that are screen printed through a patterned screen onto the substrate so as to define a piezoelectric area that drives the liquid crystal layer. The piezoelectric layer can be in a form of an overcoat of the substrate comprising piezoelectric particles dispersed in a polymer. The piezoelectric layer can be in a form of an overcoat of the substrate comprising piezoelectric particles dispersed in a material that separates and does not dissolve in the cholesteric liquid crystal.

In another aspect of the second inventive concept there are two of the liquid crystal layers each including the second electrodes on both sides thereof. The piezoelectric layer is disposed between the liquid crystal layers. Both of the second electrodes sandwiching the liquid crystal layers include one second electrode including rows or columns and the other second electrode that is unpatterned. The first electrodes include one first electrode being unpatterned and another first electrode being patterned as columns or rows. The liquid crystal layers can include cholesteric liquid crystal of opposite chiral handedness. Alternatively, the liquid crystal layers can include cholesteric liquid crystal that reflects light of different colors.

A third inventive concept features a multiplexed driving scheme for driving a display device comprising providing the display device described in the second inventive aspect above. An array of pixels of the liquid crystal layer displays a digitally addressed image. The pixels are created by a matrix of electrodes obtained by patterning one of the first electrodes as one of columns or rows and the other of the first electrodes sandwiching the piezoelectric layer being unpatterned. One of the second electrodes is patterned as the other of columns or rows and the other of the second electrodes sandwiching the liquid crystal layer being unpatterned. The rows and columns are approximately orthogonal to one another. The pixels are defined by an intersection of the rows and columns. The piezoelectric layer is electrically driven by driving the first electrodes one column or row at a time. Each driven column or row defining a line segment of the image, thereby causing the piezoelectric layer to change shape along the driven column or row which drives the planar texture of the liquid crystal layer. While the column or row of the first electrodes is driven, data is simultaneously placed on a corresponding line segment of the liquid crystal layer by applying data voltages to the other of the columns or rows of the second electrodes sandwiching the liquid crystal layer which drives the focal conic texture of the liquid crystal layer. Image data is therefore addressed to the liquid crystal layer one line at a time sequentially to create a full image.

Referring to specific features of the third inventive concept, crosstalk between a piezoelectric driven line, which is a line of the column or row of the liquid crystal layer being driven by the changing of shape of the piezoelectric film, and other undriven lines is reduced or prevented by applying the data voltage that is less for the piezoelectric driven line than the data voltage for the undriven lines. Gray levels for each pixel can be controlled by controlling a magnitude of the data voltages.

A fourth inventive concept features a multiplexed driving scheme for driving a display device comprising providing the display device of the second inventive concept. One of the first electrodes is patterned as columns or rows and the other of the first electrodes is unpatterned. The second electrodes are patterned as columns or rows. An array of pixels displays a digitally addressed image. The pixels are created by a matrix of electrodes obtained by columns or rows of the first electrodes and the other of columns or rows of the second electrodes. The rows and columns are approximately orthogonal to one another, and the pixels being defined by an intersection of the rows and columns. An image is electrically addressed on the display device by first driving each line on the liquid crystal layer to the planar texture by sequentially applying appropriate voltages to the columns or rows of the first electrodes and then placing a focal conic image on the liquid crystal layer with a planar background by applying voltages to the patterned second electrodes.

A fifth inventive concept features a multiplexed driving scheme for driving a display device comprising providing the display device of the second inventive concept. One of the first electrodes is patterned as rows and the other of the first electrodes is patterned as columns, the rows and the columns being substantially orthogonal to each other. Both of the second electrodes are unpatterned or one of the second electrodes is patterned as rows or columns. An array of pixels of the liquid crystal layer displays a digitally addressed image. The pixels are created by a matrix of electrodes obtained by columns or rows of the first electrodes and the second electrodes. The pixels are defined by an intersection of the rows and columns. An image is addressed on the liquid crystal layer by first initializing the texture to the focal conic texture. The piezoelectric layer is electrically driven by driving the first electrodes one column or row at a time, each driven column or row defining a line segment of the image and by applying image data for driving the other of the columns or rows of the first electrodes, thereby causing the piezoelectric layer to change shape along intersections of the driven columns and rows to drive the planar texture of the liquid crystal layer according to that demanded by the data. Image data is therefore addressed to the liquid crystal layer one line at a time sequentially to create a full image.

More specifically, the piezoelectric layer has a threshold sufficient to prevent crosstalk for line-at-a-time driving. Voltages can be applied to the second electrodes to erase the image after the image has been addressed.

A fifth inventive concept features the display device of the second inventive concept and a writing tablet comprising a flexible substrate, the bistable liquid crystal layer and the second electrodes, wherein a texture of the cholesteric liquid crystal is changed by application of pressure to the substrate.

Any of the specific features described above with regard to the first and second inventive concepts apply to the fifth inventive concept. In particular, the light absorbing layer can be disposed at a back of the display device.

It should be appreciated that relative words have been used in the description and claims to improve understanding, such as top, bottom, upper, lower, front, back, columns, rows. These terms can change depending on the orientation of the display device, and should not be used to limit the invention as described by the claims.

### FIGURE DESCRIPTIONS

FIG. 1: An illustration of embodiment 1a

FIG. 2: An illustration of embodiment 1b in which all of the substrates are from PVDF films.

FIG. 3: An illustration of embodiment 1c

FIG. 4: A Block diagram of the electronic drive circuitry for embodiments 1a, 1b, and 1c.

FIG. 5: An illustration of embodiment 1d.

FIG. 6. A block diagram of the electronic drive circuitry for embodiment 1d.

FIG. 7: An illustration of embodiment 2.

FIG. 8: Block diagram for the electronic drive circuitry for embodiment 2.

FIG. 9: An embodiment 3 in which a single piezoelectric layer drives two cholesteric layers simultaneously.

FIG. 10: An embodiment 4 in which a single piezoelectric layer with patterned electrodes is used to drive multiple cholesteric layers with unpatterned electrodes.

FIG. 11: An illustration of an embodiment 5 for a stacked cell configuration for achieving multiple colors.

FIG. 12: An illustration of embodiment 6.

FIG. 13: Photograph in Example 1 showing the writing tablet at the intersection of the Cr/Au electrodes in the initial (left) focal conic state and after switching (right) in the planar state.

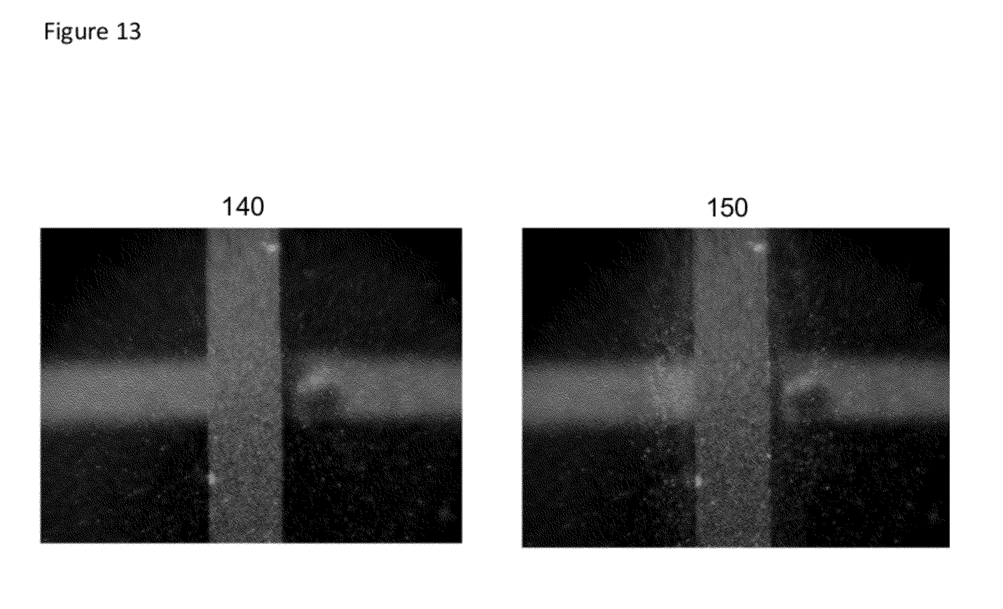

### DETAILED DESCRIPTION

Several different embodiments of display devices are provided below.

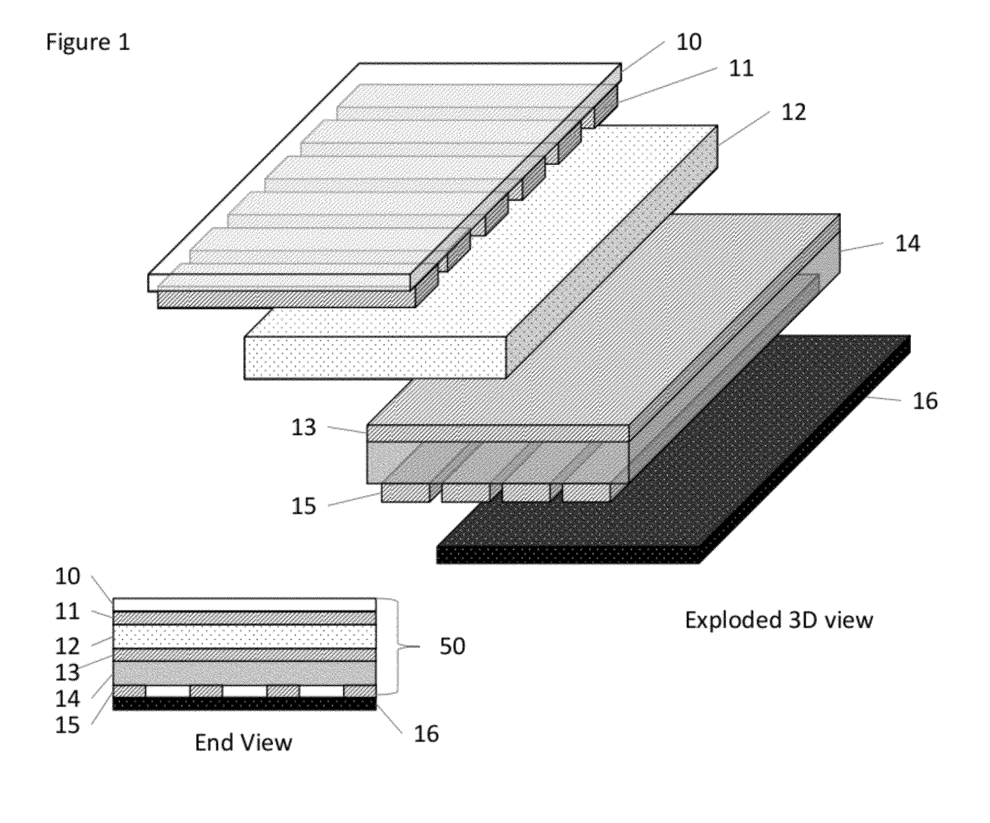

Embodiment 1a of the digital imaging device is shown in FIG. 1 where the columns of the piezoelectric film are selected and driven while the data is applied to the rows of the cholesteric layer. In this embodiment, a piezoelectric film 14 is used as one of the substrates for the cholesteric liquid crystal material 12. This embodiment is to take advantage of reduced threshold voltages provided by the cholesteric material during the time strain is induced by the piezoelectric layer. A discussion of the operation of a writing tablet that can be used in this disclosure is provided in the following paper, T. Schneider, G. Magyar, S. Barua, T. Ernst, N. Miller, S. Franklin, E. Montbach, D. Davis, A. Khan, J. W. Doane, “A Flexible Touch-Sensitive Writing Tablet,” SID Intl. Symp. Digest Tech. Papers, 39, 1840 (2008), which is incorporated herein by reference in its entirety. In the absence of strain there is a threshold voltage as described in U.S. Pat. Nos. 5,251,048 and 5,644,330 (which are incorporated herein by reference in their entireties) when driving from the planar to the focal conic texture. While strained the voltage threshold is reduced due, in part, to a reduced inner electrode spacing of the liquid crystal layer. With the piezoelectric material serving as a substrate for the cholesteric liquid crystal layer, strain in the cholesteric liquid crystal layer can be more localized and the digital image can be of higher resolution. In this embodiment, the liquid crystal may also be more sensitive to the stress or pressure imposed by the piezoelectric film, thereby reducing the power required to switch the cholesteric material. One preferred piezoelectric film 14 in FIG. 1 is a polymer film such as PVDF or a microcrystalline composite that has been suitably poled or polarized to exhibit stress and strain in the cholesteric liquid crystal layer 12. Substrate 10 serves as the upper substrate to the cholesteric layer on the viewing side of the device, the other side being the bottom of the display. Substrate 10 is preferably a flexible transparent plastic although it could also be rigid glass if the display is to be used only for displaying digital images and not used as a writing tablet. The preferred cholesteric material 12 is a dispersion of a bistable cholesteric liquid crystal within a polymer network such as to regulate and localize the flow of the liquid crystal (see U.S. Patent Application Publication 2009/0033811, which is incorporated herein by reference in its entirety) under the pressure imposed by the piezoelectric film. On both sides of the piezoelectric film is coated, printed, sputtered or laminated conducting films 13 and 15. With the piezoelectric film being the bottom substrate, the conductors may be opaque and absorb light but they should not reflect light as reflected light from the conductors will diminish the contrast of the cholesteric displayed image. A third transparent conductor, 11, is coated, printed, sputtered or otherwise laminated on the lower side of substrate 10. A matrix of pixels can be made by patterning the conductor 15 as columns and conductor 11 as rows. Even though the columns are not in close proximity to the liquid crystal layer, the columns and the rows correspond to pixels in the liquid crystal layer because when voltages are applied across the columns of the piezoelectric layer and electrode layer 13 and across the rows of the liquid crystal layer and the electrode layer 13, the reflectance of the liquid crystal at the intersection of the rows and columns where the voltage is applied, is controlled. It should be appreciated in view of this disclosure that the position of the columns 15 and the rows 11 could be reversed, i.e., rows could be located below the piezoelectric film 14 and columns could be located above the liquid crystal layer 12. The conductor 13, common to both the piezoelectric film 14 and the liquid crystal 12, is an unpatterned continuous film that in typical operation is held to ground. A black or colored absorbing layer 16 is used on the bottom of the display cell particularly if electrodes 13 and 15 are not opaque. Layer 16 also provides inertia that enables the piezoelectric film 14 to deliver strain to the cholesteric layer 12.

A passive matrix is driven by applying AC or DC voltage pulses to electrode 13 and column electrodes 15. Each column electrode 15 is sequentially driven one column at a time through all the columns. The strain induced by the piezoelectric film on a particular column will drive a line of the cholesteric liquid crystal toward the planar texture. While each column is being driven, data is simultaneously placed on all of the rows intersecting that column, selectively controlling the extent a particular pixel in that row is driven to the planar texture and hence the brightness level of each pixel in that row. Cross talk in applying data voltages to subsequent columns is prevented by suitable threshold voltages. It is expected that it may be possible to drive video rate images using this embodiment, provided the piezoelectric material can be switched fast enough. Cumulative driving (see U.S. Pat. No. 6,133,895, which is incorporated herein by reference in its entirety) may also be possible with this display architecture. A possible limitation of this shared substrate/electrode display design is the coupling of the electric fields driving the piezoelectric film and the electric fields driving the liquid crystal layer. Too large a drive voltage for the piezoelectric film may cause fields that interfere with fields from the data voltages applied to the liquid crystal electrodes.

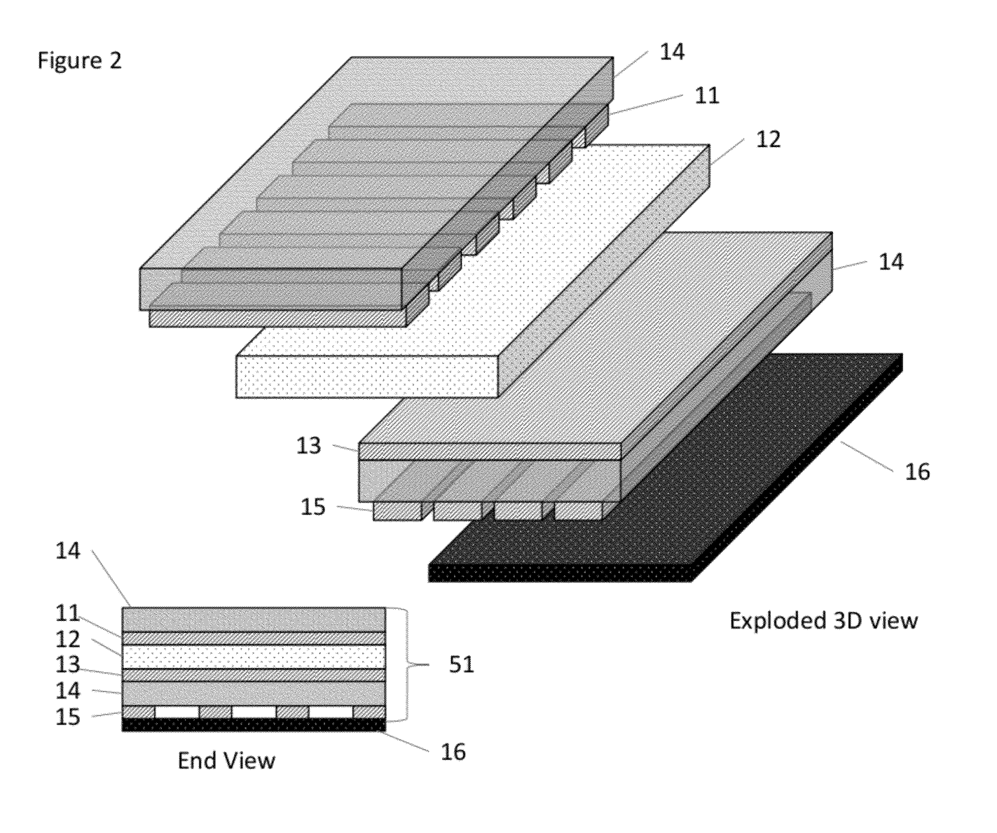

Embodiment 1b is similar to embodiment 1a except that substrate 10 in FIG. 1 is replaced by a PVDF film 14 in FIG. 2. This embodiment is possible since the PVDF film is sufficiently see-through or transparent to serve as an upper substrate. The mechanical and chemical ruggedness of PVDF films and their availability at low cost make them suitable for this application as well as being used as a piezoelectric film. Further enabling this embodiment is the use of transparent conducting polymer as the electrode. Indium tin oxide (ITO), conductive polymer (CP), or conductive carbon nanotubes may also be used as a transparent conductor.

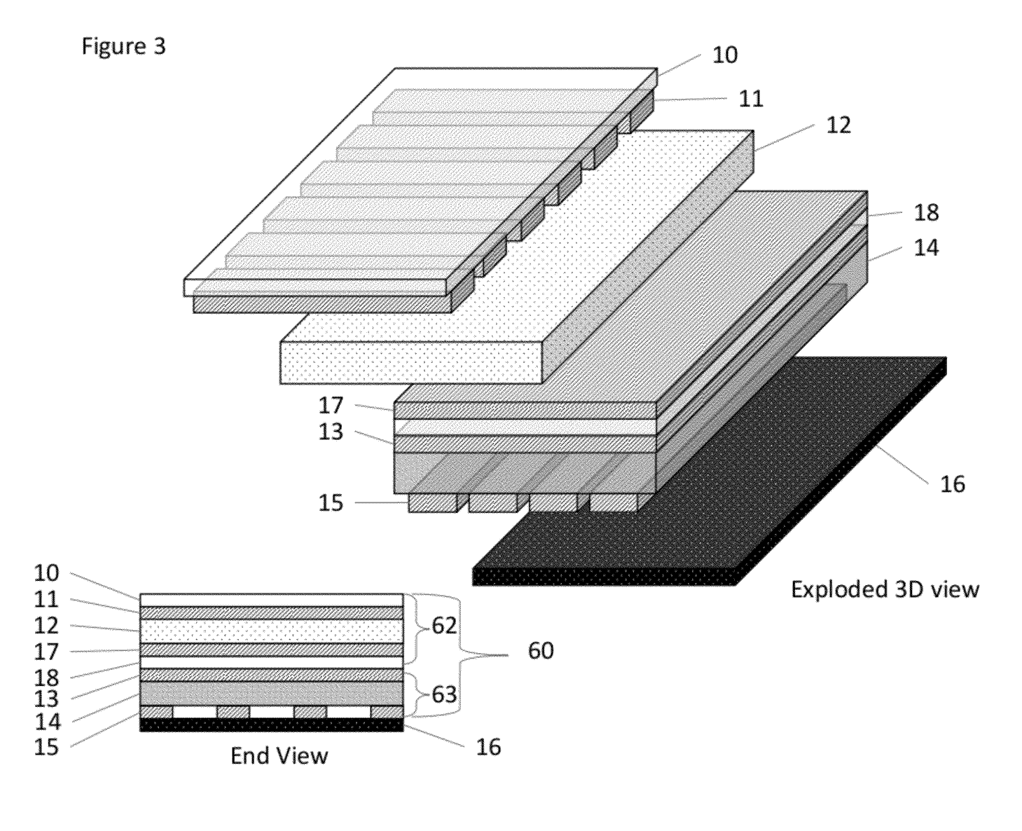

Embodiment 1c, which is a modification of embodiment 1a, is disclosed in order to provide a substrate between the cholesteric layer and the piezoelectric film. This embodiment further is designed to simplify fabrication of the device. The embodiment illustrated in FIG. 3 is similar in design as embodiment 1 except the cholesteric display 62, and the piezoelectric column driving unit 63, are two separate units. This design reduces the residual electric field from the piezoelectric film electrodes and has the advantage of being simpler to fabricate with the display 62 and the piezoelectric driver 63 being two separate units. A disadvantage may be that the resolution and sensitivity to the piezoelectric stress may be limited. FIG. 3 is different from FIG. 1 in that, an additional substrate 18 with a conductor 17 is inserted in the stack of layers. The piezoelectric driving unit 63 and the tablet 62 (e.g., the Boogie Board™ writing tablet) share the same substrate in FIG. 3 when assembled although each unit could have a separate substrate (not shown). Voltage pulses are applied to conductors 13 and 15 to drive the piezoelectric film 14. In this device one of the conductors 13 or 15 is patterned as columns while the other conductor is unpatterned. Likewise, one of conductors 11 or 17 is patterned as rows while the other conductor is unpatterned. The driving of this embodiment can be the same as described in embodiment 1a.

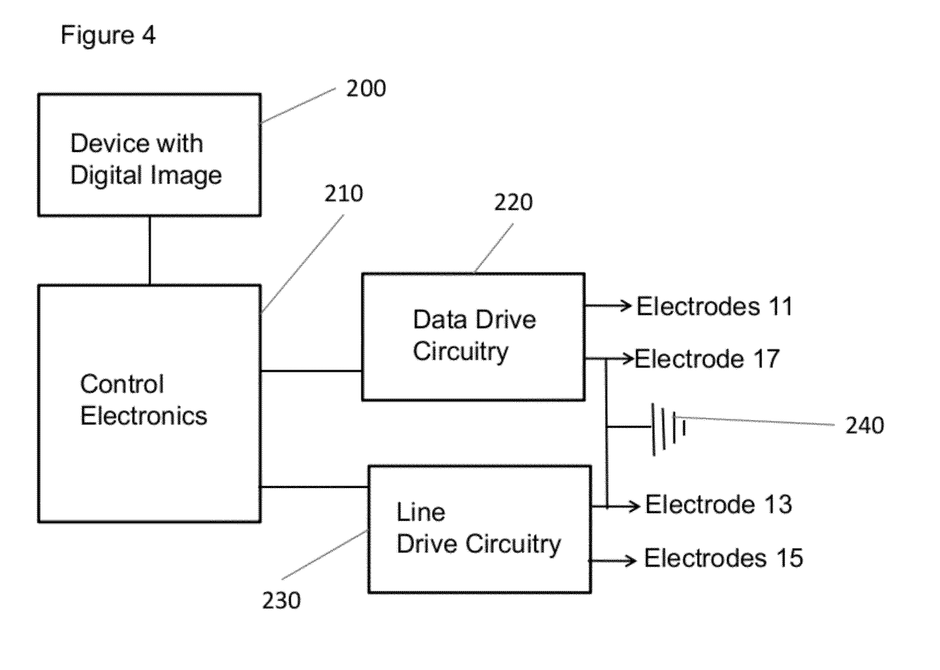

A block diagram of the circuitry for driving the displays of Embodiment 1 is shown in FIG. 4. Data for a digital image is provided by an electronic device, 200, which may be a PC, cell phone, eBook, camera, or related device. Device 200 sends the data to controller 210 that provides the appropriate digital signals to the data drive circuitry 220 and the line select drive circuitry 230. Drive circuitry 230 provides drive voltage pulses to the conducting electrode 15 of a selected column resulting in a voltage drop across the column electrode 15 and the continuous electrode 13 normally held to ground, 240. This voltage drop is of sufficient magnitude and duration to drive the piezoelectric layer such that it provides strain to the adjacent cholesteric liquid crystal layer driving the layer to the reflective planar texture. Each column is sequentially selected. During the time a selected column is being driven to the planar texture data voltages are supplied simultaneously to each of the row conducting electrodes 11. The data voltages provide a voltage between each of the row electrodes and the continuous electrode 17, normally held to ground 240. The location where each row intersects with the driven column defines a pixel of the liquid crystal layer. The voltage drop drives the liquid crystal toward the focal conic texture and if large enough will prevent the strain induced by the piezoelectric layer from driving the reflective planar texture. If there is no voltage drop at a particular pixel site the reflective planar state will be driven by the piezoelectric layer. A pixel is then either ON (reflective) or OFF (non reflective) depending upon the value of the data voltage at a particular pixel. Intermediate voltages can create gray levels; i.e., different levels of reflective brightness between a maximum brightness of the planar texture and a minimum brightness of the focal conic texture. The full image is placed on the display by sequentially selecting each line on the display one line (i.e., column) at a time while applying the appropriate data voltages for each of the rows intersecting the line. Cross talk between the selected and unselected line (e.g., column) is prevented by the phenomenon whereby the planar texture already addressed on the unselected lines has a higher voltage threshold than the line that is currently being driven. This comes about for different reasons, one being that the inner electrodes spacing on the line being driven is less because of the strain, lowering the threshold.

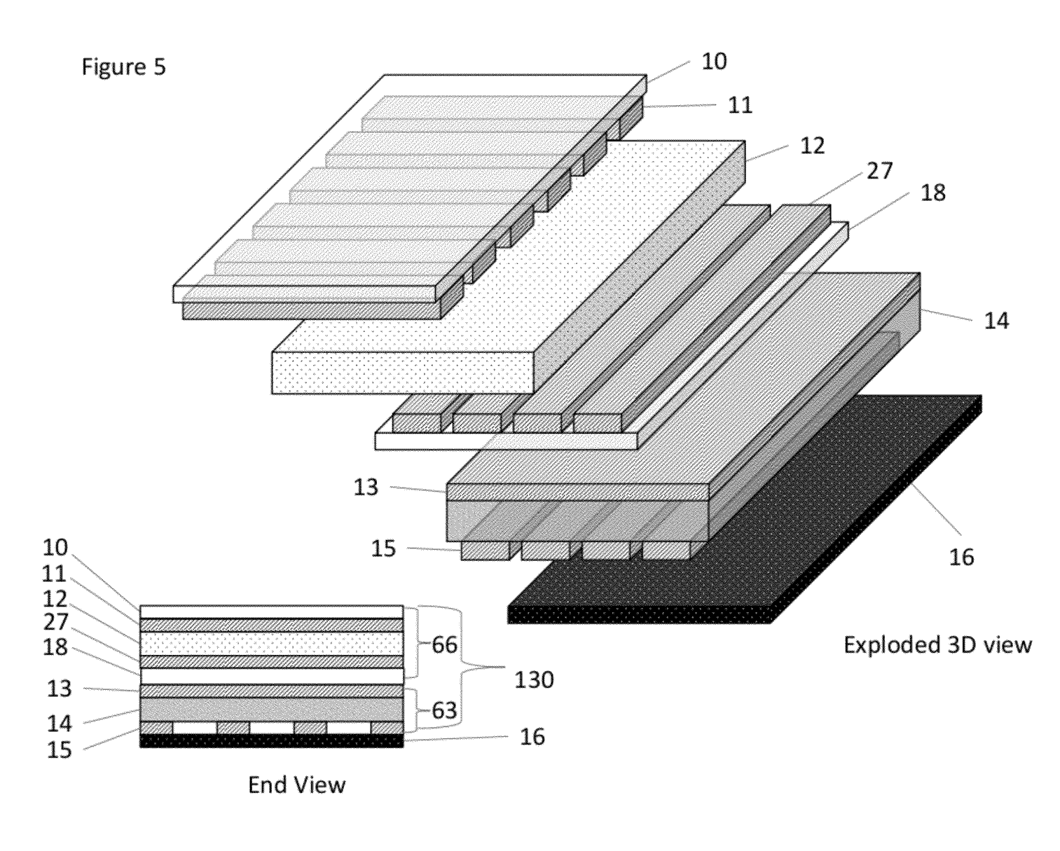

Embodiment 1d is a modification of 1c where both electrodes sandwiching the cholesteric liquid crystal are patterned, one as columns 27 and the other as rows 11 as illustrated in FIG. 5. In this embodiment the piezoelectric layer 14 first drives the liquid crystal layer 12 to the planar texture then, at a later time, the focal conic data is placed on the liquid crystal layer 12 to create the image. The piezoelectric layer can be driven one line at a time sequentially using electrodes 13 and 15 until all or a portion of the columns 15 have driven liquid crystal layer 12 to the planar texture. Alternatively, more than one piezoelectric column electrode 15 may be simultaneously driven until all or a portion of the liquid crystal film 12 is driven to the planar texture. Once all or a portion of the liquid crystal layer 12 is in the planar texture, an image is addressed on that portion by data voltages placed on row electrodes 11 and column electrodes 27 in a multiplexed fashion by driving the focal conic texture as is demanded by the image. Multiplex driving of cholesteric liquid crystal layer with row and column electrodes is well known in the art of bistable reflective displays such as described in U.S. Pat. Nos. 5,644,330 and 5,889,566, which are incorporated herein by reference in their entireties. In this case where the planar texture has been previously driven, the row and column voltages are combined to address the bistable cholesteric material one line at a time by applying voltages to a column electrode 27 while simultaneously applying data voltages to row electrodes 11, driving the focal conic texture as demanded by the image for each pixel where the rows and columns intersect. Crosstalk with the previously addressed lines is prevented by the sharp threshold between the planar texture and the focal conic texture that results when the planar texture is driven by the mechanical strain imposed by the piezoelectric material. The unit 66 can be a tablet (e.g., the Boogie Board™ writing tablet).

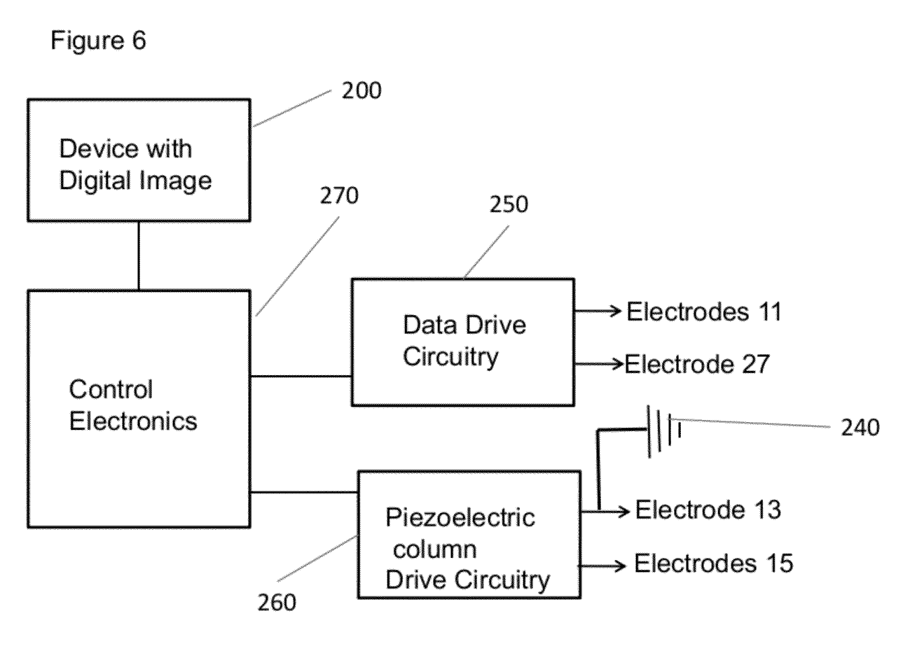

A block diagram of the driving circuitry of embodiment 1d is shown in FIG. 6. Data for a digital image is provided by an electronic device, 200, which may be a PC, cell phone, eBook, camera, or related device. Device 200 sends the data to controller 270 that provides the appropriate digital signals to the data drive circuitry 250 and piezoelectric column drive circuitry 260. Drive circuitry 260 provides drive voltage pulses to the conducting electrode 15 of a selected column resulting in a voltage drop across the column electrode 15 and the continuous electrode 13 normally held to ground, 240. This voltage drop is of sufficient magnitude and duration to drive the piezoelectric layer such that it provides strain to the adjacent cholesteric liquid crystal layer 12 driving the layer to the reflective planar texture. Each column is sequentially or collectively selected as described above for this embodiment. Data drive circuitry 250 provides the drive voltages pulses to the row and column electrodes 11 and 27 respectively in a multiplexed manner, sequentially driving a focal conic image on the planar texture as described above for this embodiment, 1d.

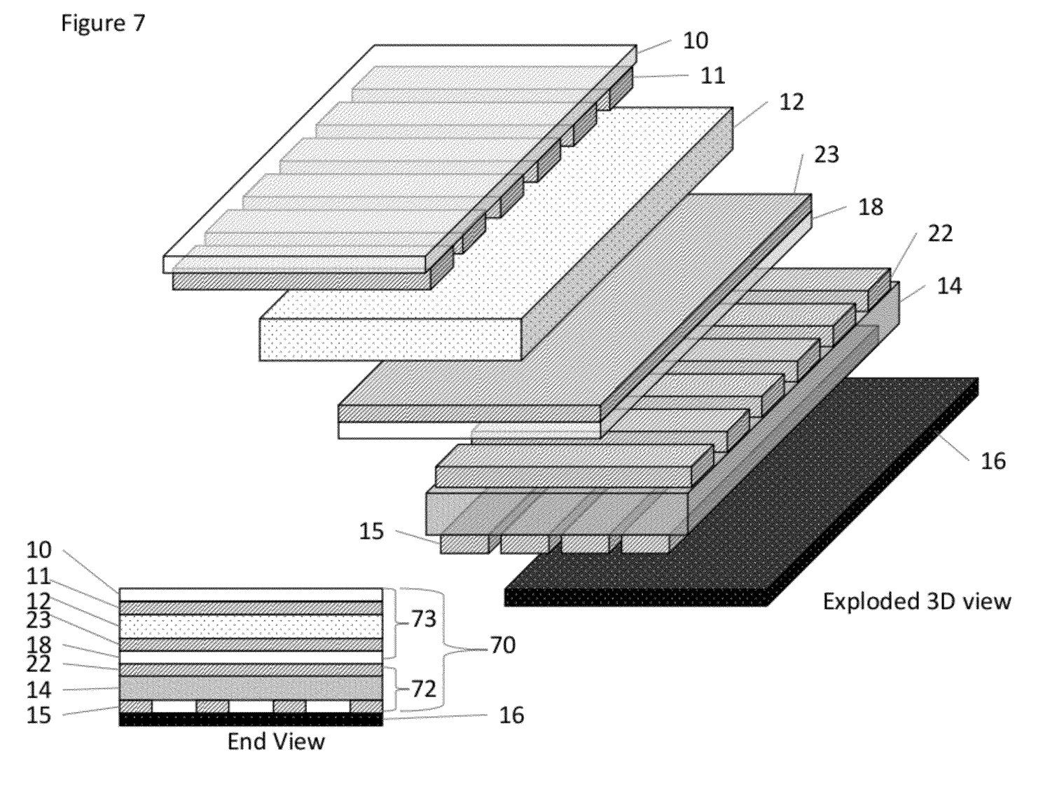

Embodiment 2: As shown in FIG. 7, this embodiment is for a case where the piezoelectric film has a sufficient voltage threshold to be used for driving a pixel array from a matrix established by patterned row and column electrodes sandwiching the piezoelectric material. In FIG. 7 the piezoelectric driver 72 includes a piezoelectric film 14 with conducting layer 22 patterned as rows and conducting layer 15 patterned as columns, or vice versa. The piezoelectric film can be driven one column at a time with column electrodes 15, while the rows 22 are addressed with data voltages applied to the rows of each addressed column simultaneously with or without holding voltages applied to the electrodes 11 and 23 of the cholesteric layer. The resolution of the image will depend upon the sharpness of voltage thresholds. Poor thresholds can result in cross talk between rows and will destroy the image. The piezoelectric driver 72 shares a substrate 18 with tablet 73 (e.g., a writing tablet such as the Boogie Board™) when assembled, with patterned electrodes 11 and an unpatterned electrode 23 sandwiching the cholesteric material 12. It should be appreciated that the unpatterned electrode 23 could be replaced by a patterned column electrode, (it being possible to switch the location of the row and column electrodes sandwiching the liquid crystal layer), so that each pixel of the liquid crystal layer could be independently placed in the focal conic texture. A voltage pulse can be applied to the electrodes 11 and 23 to drive the cholesteric material to the focal conic state or hold the material in the focal conic state while the piezoelectric film is driving the cholesteric material. Driving the focal conic state can remove the planar texture and erase the image. Electrode 11 may be optionally patterned as illustrated in FIG. 7 or unpatterned. A reduction in cell gap while the cholesteric state is being strained by the piezoelectric layer will also affect the threshold voltage used for driving or holding the focal conic state. This embodiment can also employ strain or pressure of the piezoelectric film to drive varying levels of brightness or shades of gray. When units 72 and 73 have separate substrates (not shown in FIG. 7) an adhesive may be used to glue the piezoelectric driver 72 to the writing tablet 73. A light absorbing layer 16 is coated on the back of the digitally driven tablet cell 70.

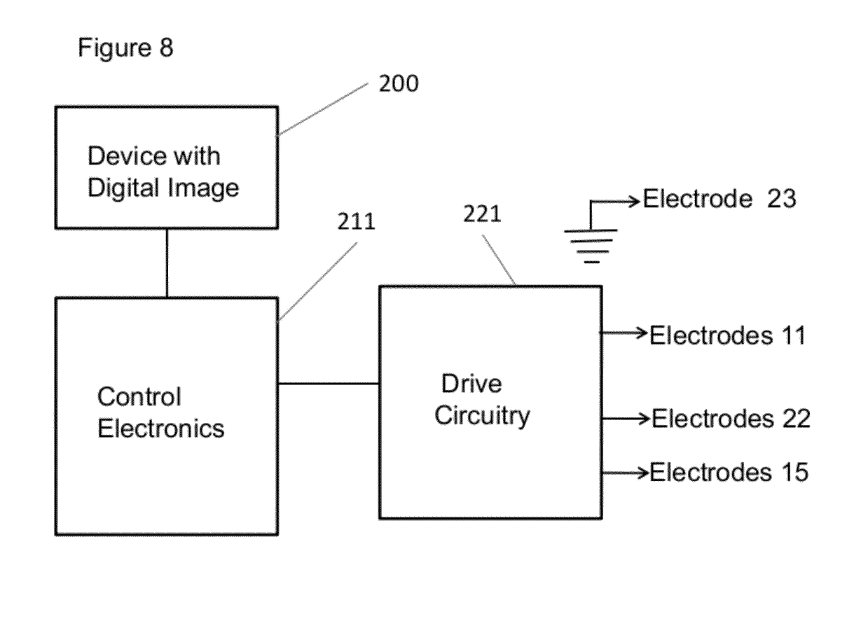

A block diagram of the circuitry for driving the displays of Embodiment 2 is shown in FIG. 8. Data for a digital image is provided by an electronic device, 200, which may be a PC, cell phone, ebook, camera, or related device. Device 200 sends the data to controller 211 that provides the appropriate digital signals to the drive circuitry 221. This embodiment requires a piezoelectric material with a suitable voltage threshold so that multiplexing may be used in driving the piezoelectric layer one line at a time. In this case drive voltages are applied by drive circuitry 221 to the row conductors 22 and column conductors 15 that sandwich the piezoelectric layer. Appropriate voltage pulses are supplied to the passive matrix sandwiching the piezoelectric layer 14 as is known in the art of display technology. Strain induced at a particular pixel site of the liquid crystal layer, defined by the intersection of the rows and columns, will induce the reflective planar texture. The brightness of the planar texture induced at a particular pixel site depends on the amount of strain induced. Therefore, gray scale may be induced by varying the voltage to the piezoelectric layer which changes the extent that layer applies force to the liquid crystal layer. The non-reflective focal conic texture is driven by a voltage drop across the electrodes 11 and 23. That voltage may be applied before, during or after the planar state is driven by the passive matrix. Voltages may be applied to erase an image after it has been addressed by the piezoelectric layer. In this case electrode 11 may be continuous rather than patterned in rows as illustrated in FIG. 5. Alternatively, the voltage drop across electrodes 11 and 23 may be applied to initialize the display to the focal conic state before addressing the reflective image with the piezoelectric layer. If the electrode 23 is patterned as columns, the focal conic texture of each individual pixel can be controlled. Still another approach is to apply voltages during the time the piezoelectric layer is been line-at-a-time passively addressed. This may be used to adjust the display brightness. In this embodiment gray levels are introduced by the piezoelectric layer.

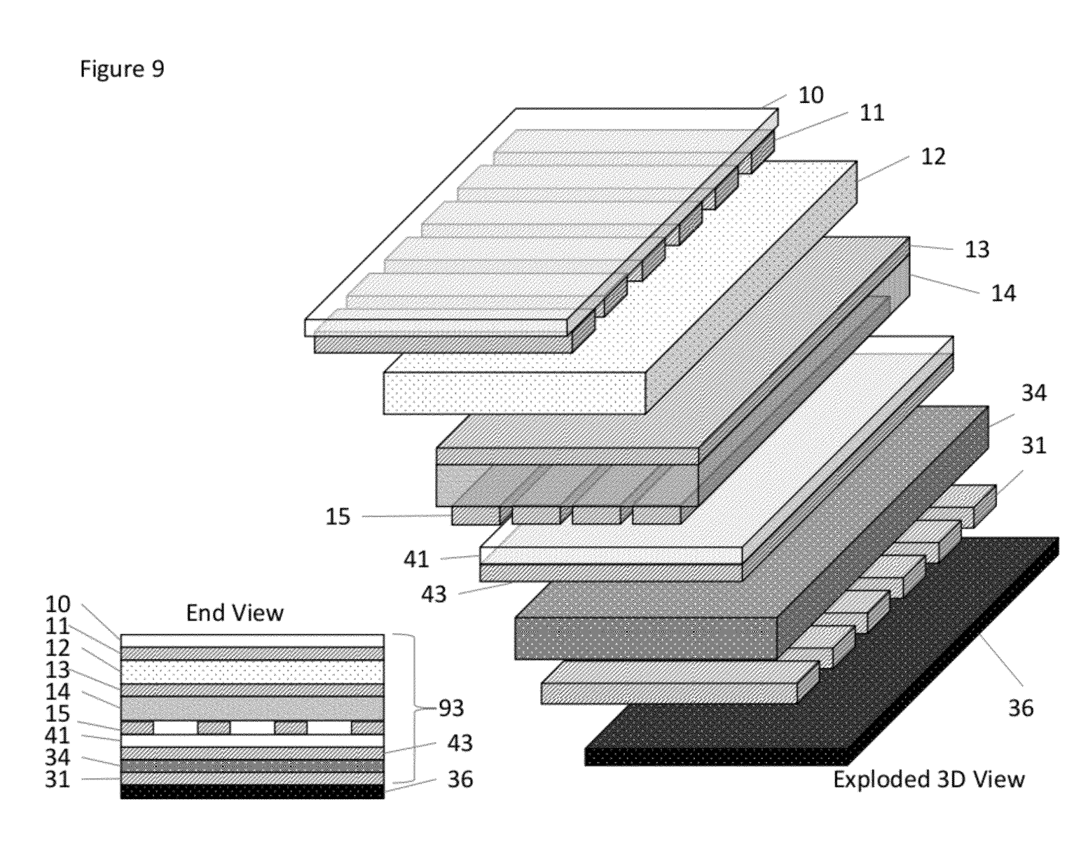

Embodiment 3 of FIG. 9 is a display cell configuration for enhanced brightness where both left and right circular polarized light is reflected, for example. (see, for example, U.S. Pat. No. 6,532,062). In this embodiment piezoelectric film 14 with conductors 13 and 15 drives the planar texture of cholesteric layer 12 of one chiral handedness as well as the planar texture of cholesteric layer 34 of the other chiral handedness. Electrodes 11 and electrodes 13 drive the focal conic texture of liquid crystal layer 12 while electrodes 31 and 43 drive the focal conic texture of liquid crystal 34. An insulating layer 41 separates conductors 15 and 43. The electrodes 15 are patterned as columns and the electrodes 11 and 31 are patterned as rows. Layer 36 is blackened to absorb light providing contrast for the light reflected by the cholesteric films. Alternatively, this hybrid cell configuration may be used to drive two separate reflective colors such as blue and yellow to achieve a white on black display. If the electrodes 15 are patterned as rows, then the electrodes 11 and 31 can be patterned as columns. Each of the liquid crystal display units can be tablets (e.g., the Boogie Board™ writing tablet).

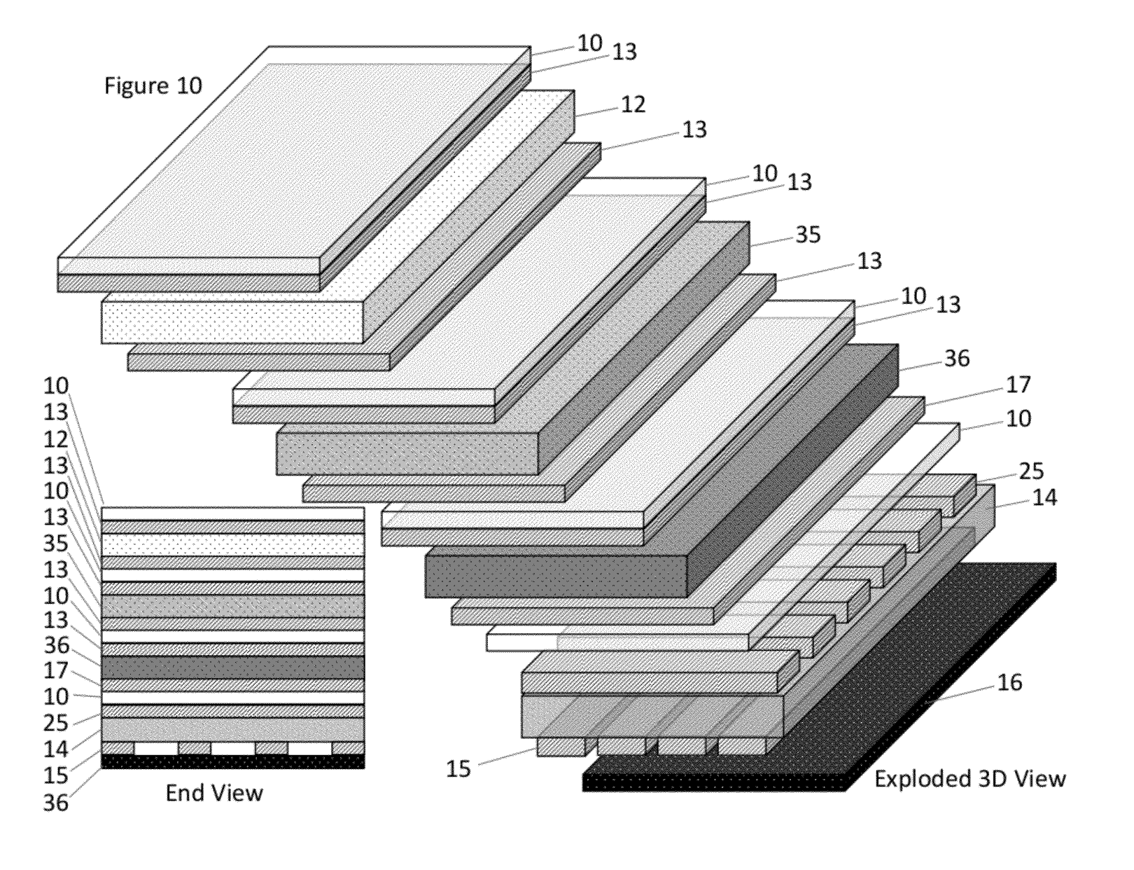

Embodiment 4 of FIG. 10 is a stacked device for achieving multiple color images using a single piezoelectric layer 14 to drive a red 36, green 35, and blue 12 reflecting stack of cholesteric layers simultaneously. This is similar to the tablet as described in published U.S. patent application 2009/0033811 except the action of the stylus is replaced by that of the piezoelectric layer. In this embodiment, the piezoelectric layer is electrically shielded by the continuous solid conductor 17 of the cholesteric layer which may be held to ground while driving the piezoelectric layer 14. The cholesteric layers are written to the planar texture by passively addressing the piezoelectric layer. The electrodes 13 and 13 (sandwiching the upper cholesteric layer 12), 13 and 13 (sandwiching the middle cholesteric layer 35), and 13 and 17 (sandwiching the lower cholesteric layer 36) are then used to switch each of the cholesteric layers to the focal conic state or select the grayscale while driving the piezoelectric layer. A light absorbing layer 16 is on the back of the display and can be used as a substrate to provide inertia for the piezoelectric layer.

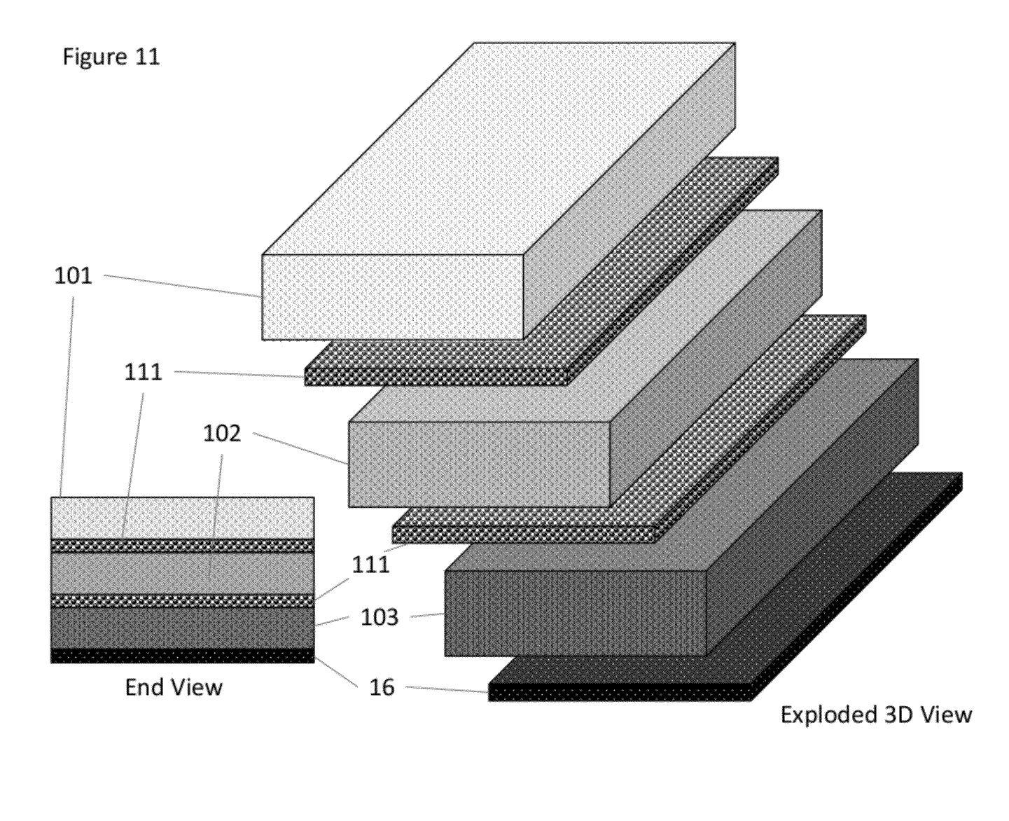

Embodiment 5 of FIG. 11 is a stacked device for achieving multiple color images. Display cell 101 may be a cell configured as 50, 51, 60, 70, or 93 with a cholesteric liquid crystal layer that can show a red reflective colored digitally addressed image. Likewise display cell 102 can be a cell configured as 50, 51, 60, 70, or 93 with a cholesteric liquid crystal layer that can show a green digitally addressed image. Similarly, display cell 103 can be a display cell configured as 50, 51, 60, 70, or 93 with a cholesteric liquid crystal layer that can show a blue reflective color digitally addressed image. With all of the conducting electrodes being transparent, display cells 50, 51, 60, 70, or 93 may be stacked to provide a multiple color display in the same manner as U.S. Pat. No. 6,377,321. FIG. 11 is an illustration of a triple stack device to achieve full color images. In FIG. 11, stacked display cells 101, 102 and 103 are stacked with an optical coupling adhesive 111 between them which also serves as a mechanical strain isolator for the piezoelectric film. A light absorbing layer 16 is on the back of the display.

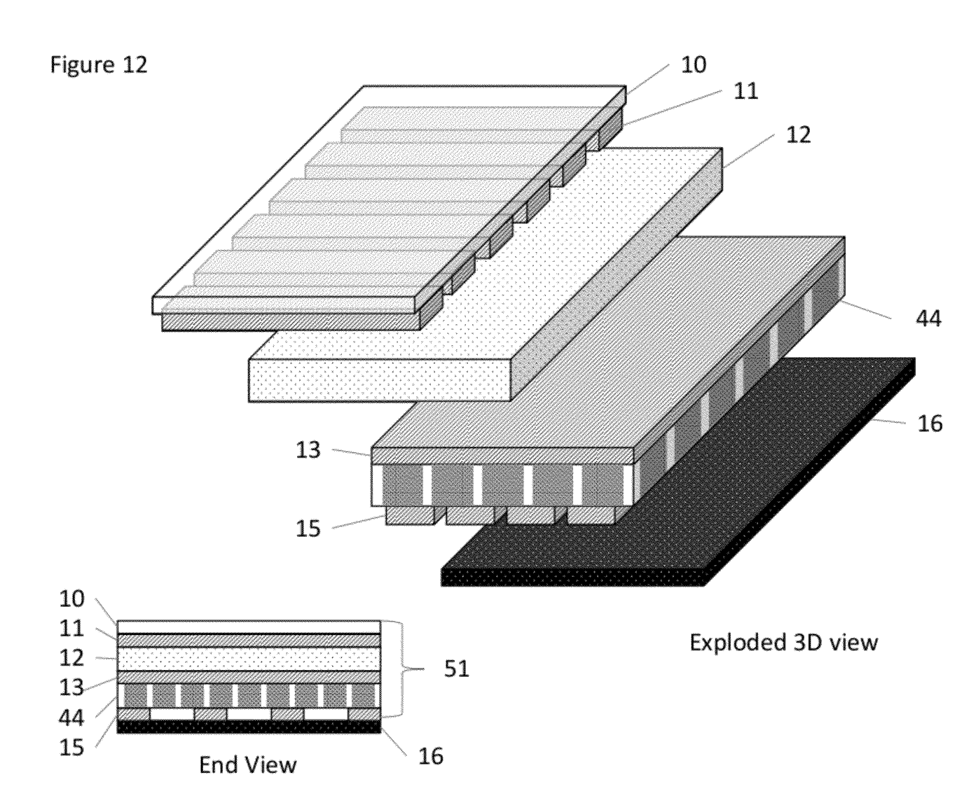

Embodiment 6, illustrated in FIG. 12, is a display in which the piezoelectric layer 44 is comprised of posts of piezoelectric material. The posts 44 may be randomly distributed, patterned or distributed in a regular array as illustrated in FIG. 12. FIG. 12 illustrates the use of posts as they are incorporated in a display configuration of embodiment 1. It is to be understood however that they may be used in other display configurations such as embodiment 2, for example. The posts may be made by screen printing a polymer composite of micron size crystallites or may be a collection of solid, flat ceramic piezoelectric posts for example.

Other embodiments, modifications and variations of the disclosed device and concepts will be apparent to those of ordinary skill in the art in light of the foregoing disclosure. Therefore, it is to be understood that, within the scope of the disclosure, the concept of addressing a pressure sensitive tablet with a digital image using a piezoelectric material can be practiced otherwise than has been specifically shown and described.

### EXAMPLES

### Example 1

### Driving a Cholesteric Liquid Crystal from the Focal Conic to the Planar Texture Using a Copolymer Film of P(VDF/TrFE)

A poled piezoelectric sheet was purchased from Piezotech S.A.S. in Hesingue, France. The 40 micrometer thick piezoelectric sheet with a dielectric constant d33=−20 μC/N consisted of a copolymer blend of 70% Poly(vinylidene fluoride) (PVDF) and 30% Trifluoroethylene (TrFE). The piezoelectric sheet was coated with Chromium/Gold (Cr/Au) electrodes on both sides. The conductive Cr/Au electrodes were patterned on both sides of the sheet such that the top consisted of a row of conductive 100 um wide lines whereas the bottom consisted of columns of conductive 100 um wide lines. When a voltage is applied across the row-column lines, an electric field at the point of intersection causes the piezoelectric sheet sandwiched between the conductors to change thickness depending on the polarity of the voltage.

A writing tablet was made using a top substrate of 2 mil polyethylene terephthalate (PET), a 4 micron thick layer of non-encapsulated cholesteric liquid crystal (ChLC) dispersed in a polymer matrix via the PIPS method, and the piezoelectric sheet as the bottom substrate. The ChLC PIPS prepolymer was laminated between the PET and the piezoelectric sheet and cured with 1.6 mW/cm2 UVA light for 15 minutes. Note that the 2 mil PET was not coated with any conductor so the piezoelectric sheet would not switch the ChLC with an electric field—the ChLC could only be switched to the planar state by flow in this configuration. The writing tablet was then glued to a piece of glass on the side of the piezoelectric sheet using a cyanoacrylate (super) glue. In the example stack-up there was: glass on the bottom, followed by polycyanoacrylate, then Cr/Au, then the P(VDF/TrFE) copolymer piezoelectric sheet, then Cr/Au, then the ChLC PIPS dispersion, followed by a sheet of 2 mil PET that is on top. Special care was taken not to pressure point the writing tablet as it is naturally in the focal conic (non-reflective) state after curing.

A function generator (Analogic Polynomial Waveform Synthesizer Model 2020) and amplifier (Kepco BOP500M) were connected to the silver electrodes of the piezoelectric sheet of the writing tablet using conductive tape attached to the Cr/Au electrodes. The piezoelectric film was driven by applying two square-wave 500 Volt pulses that were 1000 ms (bipolar) long and 1 Hz in frequency. The ChLC within the writing tablet was filmed using dark-field microscopy to flow to the planar state from the focal conic using only the forces imparted by the piezoelectric sheet that was being deformed by the electric field, FIG. 12. In FIG. 12, we see at 140 the piezo-driven ChLC when the ChLC is initially in the focal conic texture; and we see at 150 after it was driven to the planar texture by the piezoelectric layer. This process was repeated for two more intersections and the ChLC was indeed verified to flow to the planar state using dark-field microscopy.

### Example 2

### Driving a Cholesteric Liquid Crystal Layer to the Planar Texture Using Ceramic Piezoelectric Particles

A Lead zirconate titanate (PZT) ceramic piezoelectric sensor was pulverized into a fine powder. Particles were filtered to remove large particles. Average particle size was less than 5 micrometers as measured by microscope. The particles were mixed with a polymeric binder and water mixture at 2:1 ratio of particles to binder by weight. The binder was composed of 50% water 30% polyvinyl alcohol 20% polyethylene glycol by weight.

A pressure sensitive display from a Boogie Board™ of Kent Displays, Inc. with 2 mil thick substrates was used for the cholesteric liquid crystal device. Graphite paint was applied in a 1 mm thick line to the backplane of the device as a conducting electrode. A 200 micron thick layer of PZT particles and binder was cast onto the graphite. A silver conductive paint was applied in a 1 mm thick line on the PZT particles and binder layer to form the second electrode and it was perpendicular to the graphite electrode.

The device was first driven to the focal conic texture by applying a voltage pulse (pushing the erase button) of the Boogie Board display. A 14 Hz square wave at 160V was then applied across the graphite and silver electrodes producing a clearly visible planar texture in an area roughly 1 mm in diameter at the intersection of the graphite and silver paint electrodes. The planar texture could be erased with the erase button of the Boogie Board and driven again to the planar texture with 14 Hz, 160 V square wave.

### Example 3

### Driving a Cholesteric Liquid Crystal Layer to the Planar Texture Using a Ceramic Piezoelectric Post

A solid 0.254 mm thick flat PZT ceramic piezoelectric was painted with silver conducting paint on both sides and electrically connected to an amplifier and waveform generator. On top of the piezoelectric material, a small 1 mm wide plastic post was glued with cyanoacrylate (superglue). The top of the post was glued to the bottom of a supported cholesteric writing tablet display (the Boogie Board™).

The device was first driven to the focal conic texture by applying a voltage pulse (pushing the erase button) of the Boogie Board™ display. A 5 Hz square wave at 160V was then applied across silver electrodes producing a clearly visible planar texture in the writing tablet display in an area roughly 1 mm in diameter. The planar texture could be erased with the erase button of the Boogie Board™ and driven again to the planar texture with 5 Hz, 160 V square wave. When the device was affixed under a solid plate of glass, an optimized 80V 31 Hz waveform was used to write approximately the same size feature as the 160 V waveform. The minimum voltage to write a visible dot on the Boogie Board display was 40V at 143 Hz (square wave).

What is claimed is:

1. A display device comprising:
a piezoelectric layer;
first electrically conductive electrodes disposed on both sides of said piezoelectric layer;
a bistable liquid crystal layer disposed adjacent said piezoelectric layer; and
second electrically conductive electrodes disposed on both sides of said liquid crystal layer.

2. The display device of claim 1 further comprising drive electronics for applying a first voltage to said first electrodes and a second voltage to said second electrodes.

3. The display device of claim 2 wherein said liquid crystal is cholesteric liquid crystal.

4. The display device of claim 3 wherein said first voltage is applied to said first electrodes at a magnitude that causes said piezoelectric film to change shape which in turn causes flow of liquid crystal of said liquid crystal layer, thereby driving a planar texture of said liquid crystal.

5. The display device of claim 3 wherein said second voltage is applied to said second electrodes at a magnitude that drives a focal conic texture of said cholesteric liquid crystal.

6. The display device of claim 1 wherein at least one of said first electrodes is patterned.

7. The display device of claim 1 wherein at least one of said second electrodes is patterned.

8. The display device of claim 3 wherein said liquid crystal layer comprises a dispersion of said cholesteric liquid crystal in a polymer matrix.

9. The display device of claim 2 wherein each of said first voltage and said second voltage comprises a voltage pulse.

10. The display device of claim 1 comprising a flexible substrate covering said liquid crystal layer.

11. The display device of claim 10 wherein said liquid crystal is cholesteric liquid crystal and wherein said substrate, said liquid crystal layer and said second electrodes comprise a writing tablet on which a texture of said cholesteric liquid crystal is changed by application of pressure to said substrate.

12. The display device of claim 1 comprising a light absorbing layer disposed at a back of said display device.

13. The display device of claim 1 comprising an electrically insulating layer between one of said first electrodes and an adjacent one of said second electrodes.

14. The display device of claim 1 wherein said first electrodes include an unpatterned electrode and said second electrodes include an unpatterned electrode both located between said liquid crystal layer and said piezoelectric layer and being the same electrode.

15. A display device comprising:
a piezoelectric layer;
first electrically conductive electrodes disposed on both sides of said piezoelectric layer;
a bistable liquid crystal layer comprising cholesteric liquid crystal, wherein said liquid crystal layer is adjacent said piezoelectric layer and comprises a dispersion of said cholesteric liquid crystal in a polymer matrix;
second electrically conductive electrodes disposed on both sides of said liquid crystal layer, at least one of said second electrodes being transparent; and
drive electronics for applying a first voltage to said first electrodes and a second voltage to said second electrodes, wherein said first voltage is applied to said first electrodes at a magnitude that causes said piezoelectric film to change shape which in turn causes flow of said cholesteric liquid crystal, thereby driving a planar texture of said cholesteric liquid crystal, and wherein said second voltage is applied to said second electrodes at a magnitude that drives a focal conic texture of said cholesteric liquid crystal.

16. The display device of claim 15 wherein each of said first voltage and said second voltage comprises a voltage pulse.

17. The display device of claim 15 comprising a flexible substrate covering said liquid crystal layer.

18. The display device of claim 17 wherein said substrate, said liquid crystal layer and said second electrodes comprise a writing tablet on which a texture of said cholesteric liquid crystal is changed by application of pressure to said substrate.

19. The display device of claim 15 further comprising a light absorbing layer disposed at a back of said display device.

20. The display device of claim 15 wherein at least one of said first electrodes is patterned.

21. The display device of claim 15 comprising an array of pixels of said liquid crystal layer for displaying a digitally addressed image, said pixels being created by a matrix of electrodes obtained by patterning one of said first electrodes as one of columns or rows and the other of said first electrodes sandwiching said piezoelectric layer being unpatterned, one of said second electrodes being patterned as the other of said columns or rows and the other of said second electrodes sandwiching said liquid crystal layer being unpatterned, wherein said rows and said columns are approximately orthogonal to one another with said pixels being defined by an intersection of said rows and said columns.

22. The display device of claim 21 comprising an insulating dielectric layer located between said unpatterned first electrode and said unpatterned second electrode.

23. The display device of claim 21 wherein said unpatterned first electrode and said unpatterned second electrode are located between said liquid crystal layer and said piezoelectric layer and are the same electrode.

24. The display device of claim 15 where one of said first electrodes is patterned as rows and the other of said first electrodes is patterned as columns, said rows and said columns being substantially orthogonal to each other, and wherein both of said second electrodes are unpatterned or one of said second electrodes is patterned as rows or columns and the other of said second electrodes is unpatterned.

25. The display device of claim 15 wherein said first or said second electrodes are made of a material selected from the group consisting of conducting polymer, indium tin oxide, carbon nanotubes, conductive carbon, and combinations thereof.

26. The display device of claim 15 wherein said liquid crystal layer is comprised of at least two or three different liquid crystal layers comprising said cholesteric liquid crystal, each of said liquid crystal layers being sandwiched by said second electrodes.

27. The display device of claim 26 wherein at least two of said liquid crystal layers are formed of cholesteric liquid crystal of opposite chiral handedness.

28. The display device of claim 26 wherein said liquid crystal layers include said cholesteric liquid crystal that reflects at least two of the colors of red, green and blue, each of said liquid crystal layers reflecting light of a different color.

29. The display device of claim 26 comprising only a single said piezoelectric layer for driving all of said liquid crystal layers.

30. The display device of claim 26 comprising three of said liquid crystal layers each reflecting a different one of red, green and blue, and three of said piezoelectric layers that are each disposed adjacent one of said liquid crystal layers.

31. The display device of claim 15 wherein said liquid crystal layer includes subpixels that reflect light of red, green and blue colors.

32. The display device of claim 15 wherein said piezoelectric layer comprises a composite of particles of a piezoelectric material dispersed in a polymeric material.

33. The display device of claim 15 wherein said piezoelectric layer comprises piezoelectric particles selected from the group consisting of: lead zirconate titantate, barium titanate, lead titanate, potassium niobate, lithium niobate, lithium tantalite, sodium tungstate, sodium potassium niobate, sodium niobate, bismuth ferrite, Ba₂NaNb₅O₅, Pb₂KNb₅O₁₅, and combinations thereof.

34. The display device of claim 15 wherein said piezoelectric layer is comprised of piezoelectric particles having an average diameter ranging from 1 to 300 micrometers.

35. The display device of claim 15 wherein said piezoelectric layer is comprised of piezoelectric particles having an average diameter ranging from 1 to 1000 nanometers.

36. The display device of claim 15 wherein said piezoelectric layer comprises a composite of piezoelectric crystallites dispersed in a polymer binder.

37. The display device of claim 15 wherein said piezoelectric layer comprises polyvinylidene fluoride or a copolymer blend of poly(vinylidene fluoride) and trifluoroethylene.

38. The display device of claim 15 wherein said piezoelectric layer forms a bottom substrate of said display device.

39. The display device of claim 15 comprising a substrate between said liquid crystal layer and said piezoelectric layer.

40. The display device of claim 39 wherein said piezoelectric layer comprises piezoelectric particles disbursed in a polymeric binder that are screen printed through a patterned screen onto said substrate so as to define a patterned piezoelectric area that drives said liquid crystal layer.

41. The display device of claim 39 wherein said piezoelectric layer is in a form of an overcoat of said substrate comprising piezoelectric particles dispersed in a polymer.

42. The display device of claim 39 wherein said piezoelectric layer is in a form of an overcoat of said substrate comprising piezoelectric particles dispersed in a material that separates and does not dissolve in said cholesteric liquid crystal.

43. The display device of claim 15 comprising a top and a bottom substrate that are disposed on either side of said liquid crystal layer, wherein said second electrodes are unpatterned or patterned as columns or rows and are disposed on said top and said bottom substrates, and said piezoelectric layer comprises piezoelectric posts.

44. The display device of claim 15 comprising a top and a bottom substrate that are disposed on either side of said liquid crystal layer, wherein one of said second electrodes is patterned as rows and the other of said second electrodes is patterned as columns, said rows being substantially orthogonal to said columns, said second electrodes being disposed on said top and said bottom substrates, one of said first electrodes being patterned as columns or rows and the other of said first electrodes being unpatterned, or both of said first electrodes being patterned as columns or rows.

45. The display device of claim 15 comprising two of said liquid crystal layers each including said second electrodes on both sides thereof and said piezoelectric layer being disposed between said liquid crystal layers, wherein said second electrodes sandwiching each of said liquid crystal layers include one said second electrode of rows or columns and the other said second electrode that is unpatterned, wherein said first electrodes include one said first electrode being unpatterned and another said first electrode being patterned as rows or columns.

46. The display device of claim 45 wherein said liquid crystal layers include cholesteric liquid crystal of opposite chiral handedness.

47. The display device of claim 45 wherein said liquid crystal layers include cholesteric liquid crystal that reflects light of different colors.

48. The display device of claim 15 wherein one of said second electrodes is patterned as rows and the other of said second electrodes is patterned as columns.

49. A multiplexed driving scheme for driving a display device comprising:
providing a display device comprising:
a piezoelectric layer;
first electrically conductive electrodes disposed on both sides of said piezoelectric layer;
a bistable liquid crystal layer comprising cholesteric liquid crystal, wherein said liquid crystal layer is adjacent said piezoelectric layer and comprises a dispersion of said cholesteric liquid crystal in a polymer matrix;
second electrically conductive electrodes disposed on both sides of said liquid crystal layer, at least one of said second electrodes being transparent;
drive electronics for applying a first voltage to said first electrodes and a second voltage to said second electrodes; and
an array of pixels of said liquid crystal layer for displaying a digitally addressed image, said pixels being created by a matrix of electrodes obtained by patterning one of said first electrodes as one of columns or rows and the other of said first electrodes sandwiching said piezoelectric layer being unpatterned, one of said second electrodes being patterned as the other of columns or rows and the other of said second electrodes sandwiching said liquid crystal layer being unpatterned, wherein said rows and said columns are approximately orthogonal to one another, and said pixels being defined by an intersection of said rows and said columns;
electrically driving said piezoelectric layer by driving said first electrodes one said column or said row at a time, each said driven column or row defining a line segment of the image, thereby causing said piezoelectric layer to change shape along said driven column or row which drives said planar texture of said liquid crystal layer;
while said column or said row of said first electrodes is driven, simultaneously placing data on a corresponding line segment of said liquid crystal layer by applying data voltages to the other of said columns or rows of said second electrodes sandwiching said liquid crystal layer which drives said focal conic texture of said liquid crystal layer;
whereby image data is therefore addressed to said liquid crystal layer one line at a time sequentially to create a full said image.

50. The multiplexed driving scheme of claim 49 wherein crosstalk between a piezoelectric driven line, which is a line of said column or row of said liquid crystal layer being driven by the changing of shape of said piezoelectric film, and other undriven lines is reduced or prevented by applying said data voltage that is less for said piezoelectric driven line than said data voltage for said undriven lines.

51. The multiplexed driving scheme of claim 49 comprising controlling gray levels for each said pixel by controlling a magnitude of said data voltages.

52. A multiplexed driving scheme for driving a display device comprising:
providing a display device comprising:
a piezoelectric layer;
first electrically conductive electrodes disposed on both sides of said piezoelectric layer, one of said first electrodes being patterned as columns or rows and the other of said first electrodes being unpatterned;
a bistable liquid crystal layer comprising cholesteric liquid crystal, wherein said liquid crystal layer is adjacent said piezoelectric layer and comprises a dispersion of said cholesteric liquid crystal in a polymer matrix;
second electrically conductive electrodes disposed on both sides of said liquid crystal layer, at least one of said second electrodes being transparent, one of said second electrodes being patterned as columns and the other of said second electrodes being patterned as rows;
drive electronics for applying a first voltage to said first electrodes and a second voltage to said second electrodes; and
an array of pixels for displaying a digitally addressed image, said pixels being created by a matrix of electrodes obtained by columns or rows of said first electrodes and the other of columns or rows of said second electrodes, wherein said rows and said columns are approximately orthogonal to one another, and said pixels being defined by an intersection of said rows and said columns; and
electrically addressing an image on said display device by first driving each line on said liquid crystal layer to said planar texture by sequentially applying appropriate voltages to said columns or rows of said first electrodes and then placing a focal conic image on said liquid crystal layer with a planar background by applying voltages to said columns and rows of said second electrodes.

53. A multiplexed driving scheme for driving a display device comprising:
providing a display device comprising:
a piezoelectric layer;
first electrically conductive electrodes disposed on both sides of said piezoelectric layer, where one of said first electrodes is patterned as rows and the other of said first electrodes is patterned as columns, said rows and said columns being substantially orthogonal to each other;
a bistable liquid crystal layer comprising cholesteric liquid crystal, wherein said liquid crystal layer is adjacent said piezoelectric layer and comprises a dispersion of said cholesteric liquid crystal in a polymer matrix;
second electrically conductive electrodes disposed on both sides of said liquid crystal layer, at least one of said second electrodes being transparent, wherein both of said second electrodes are unpatterned or one of said second electrodes is patterned as rows or columns;
drive electronics for applying a first voltage to said first electrodes and a second voltage to said second electrodes; and
an array of pixels of said liquid crystal layer for displaying a digitally addressed image, said pixels being created by a matrix of electrodes obtained by columns or rows of said first electrodes, wherein said pixels are defined by an intersection of said rows and said columns;
electrically driving said piezoelectric layer by driving said first electrodes one said column or said row at a time, each said driven column or row defining a line segment of the image and by driving the other of said columns or said rows of said first electrodes with data voltages, thereby causing said piezoelectric layer to change shape along intersections of said driven columns and rows to drive a texture of said liquid crystal layer;
whereby image data is therefore addressed to said liquid crystal layer one line at a time sequentially to create a full said image.

54. The multiplexed driving scheme of claim 53 wherein said piezoelectric layer has a threshold sufficient to prevent crosstalk for line-at-a-time driving, comprising erasing said image and adjusting gray levels by applying voltages to said second electrodes.

55. A display device comprising:
a piezoelectric layer;
first electrically conductive electrodes disposed on both sides of said piezoelectric layer, at least one of said first electrodes being patterned;
a writing tablet comprising:
a flexible substrate;
a bistable liquid crystal layer comprising cholesteric liquid crystal, said liquid crystal layer being disposed between said piezoelectric layer and said substrate, wherein said liquid crystal layer comprises a dispersion of said cholesteric liquid crystal in a polymer matrix;
second electrically conductive electrodes disposed on both sides of said cholesteric layer, at least one of said second electrodes being transparent;
wherein a texture of said cholesteric liquid crystal is changed by application of pressure to said substrate; and
drive electronics for applying a first voltage pulse to said first electrodes and a second voltage pulse to said second electrodes, wherein said first voltage pulse is applied to said first electrodes at a magnitude that causes said piezoelectric film to change shape which in turn causes flow of said cholesteric liquid crystal, thereby driving a light reflective planar texture of said cholesteric liquid crystal, and wherein said second voltage pulse is applied to said second electrodes at a magnitude that drives a focal conic texture of said cholesteric liquid crystal.

56. The display device of claim 55 comprising a light absorbing layer disposed at a back of said display device.
